(19) United States
(12) Patent Application Publication
(10) Pub. No.: US 2014/0245044 A1
(43) Pub. Date: Aug. 28, 2014

(54) METHOD FOR HIBERNATION CONTROL BASED ON USAGE PATTERN

(71) Applicant: barnesandnoble.com IIc, (US)

(72) Inventor: MARCOS FRID, San Carlos, CA (US)

(73) Assignee: barnesandnoble.com IIc, New York, NY (US)

(21) Appl. No.: 13/781,360

(22) Filed: Feb. 28, 2013

(51) Int. Cl. G06F 1/32

(52) U.S. Cl. CPC G06F 1/3206
USPC 713/323

(57) ABSTRACT

Apparatus and algorithms to balance power savings and convenience to users of electronic devices based on usage patterns, charging and battery efficiency and capacity, and users' subscriptions.

### RELATED APPLICATIONS

This application is related to U.S. application Ser. No. ______ (Attorney Docket BN01.825US) filed Feb. 28, 2013 and titled “Apparatus for Hibernation Control in a Device” which is herein incorporated by reference in its entirety.

This application is related to U.S. application Ser. No. ______ (Attorney Docket BN01.827US) filed Feb. 28, 2013 and titled “Method for Hibernation Control based on Charging Efficiency” which is herein incorporated by reference in its entirety.

This application is related to U.S. application Ser. No. ______ (Attorney Docket BN01.826US) filed Feb. 28, 2013 and titled “Method for Hibernation Control based on Battery Capacity” which is herein incorporated by reference in its entirety.

### FIELD OF THE DISCLOSURE

The present disclosure relates to power savings control based on defining entering a hibernation mode of operation for a device.

### BACKGROUND

Typical electronic devices utilize various form factors to include more hardware and software to support more features for applications, digital media, high resolution displays, communication, graphics and video. Consequently, less space remains for battery and energy sources. Hence, various existing solutions try to minimize the active mode of operation and allow devices to enter a standby or suspend mode, for example, a display temporarily is blank, or a deeper form of inactive operation, such as, a hibernation mode that the device powers down several portions of hardware to increase power savings. Unfortunately, this requires a longer wakeup time for the device that is a major inconvenience to the user as they need to wait for the device to initialize and become active. Present solutions for entering hibernation mode lack flexibility or insight on minimizing inconvenience to the user.

### SUMMARY

One embodiment of the present invention provides an apparatus and circuitry with software to allow a device to enter hibernation mode to reduce power usage.

One embodiment of the present invention provides a method for analyzing the charging current to determine whether the device should enter a hibernation mode.

One embodiment of the present invention provides a method for analyzing battery capacity to determine whether the device should enter a hibernation mode.

Several embodiments of the present invention provide several usage patterns for analyzing whether the device should enter a hibernation mode.

Several embodiments of the present invention utilize a combination of the following inputs to determine whether the device should enter a hibernation mode, such as, but not limited to current time of day, user's subscriptions, next scheduled wake up time to receive periodicals from a central server, device's charging efficiency, current battery capacity, and usage patterns.

### BRIEF DESCRIPTION OF THE DRAWINGS

FIG. 1 is a block diagram of an apparatus to determine hibernation policy control, in accordance with one embodiment.

FIG. 2 shows a method for charging analysis to determine entering or exiting a hibernation mode of operation, in accordance with one embodiment.

FIG. 3 shows a method for battery capacity to determine entering or exiting a hibernation mode of operation, in accordance with one embodiment.

FIG. 4 shows an apparatus with hibernation policy control, in accordance with one embodiment of the present invention.

### DETAILED DESCRIPTION

One embodiment of the present invention provides an apparatus and circuitry with software to allow a device to enter hibernation mode to reduce power usage.

One embodiment of the present invention provides a method for analyzing the charging current to determine whether the device should enter a hibernation mode.

One embodiment of the present invention provides a method for analyzing battery capacity to determine whether the device should enter a hibernation mode.

Several embodiments of the present invention provide several usage patterns for analyzing whether the device should enter a hibernation mode.

Several embodiments of the present invention utilize a combination of the following inputs to determine whether the device should enter a hibernation mode, such as, but not limited to current time of day, user's subscriptions, next scheduled wake up time to receive periodicals from a central server, device's charging efficiency, current battery capacity, and usage patterns.

As previously discussed, various existing solutions try to minimize the active mode of operation and allow devices to enter a standby or suspend mode, for example, a display temporarily is blank, or a deeper form of inactive operation, such as, a hibernation mode that the device disables several portions of hardware to increase power savings. Unfortunately, a hibernation mode requires a longer wakeup time for the device that is a major inconvenience to the user as they need to wait for the device to initialize and become active.

To facilitate descriptions of different modes of operation for electronic devices, a normal or active mode of operation allows a device to freely operate at maximum usage without any concerns for power savings. In contrast, a standby or suspend mode of operation allows for some power savings with several components and/or a display is disabled, however, the random access memory (RAM) is in a self-refresh mode that consumes power. In contrast to standby or suspend mode, a hibernation mode allows for more power savings but has significant wake up latency issues for the user. In hibernation mode, the device could be powered down completely except the state of the random access memory is stored on a disk. In this mode, a boot (or exit) from hibernation mode is faster compared to a cold boot since the RAM state is restored and the central processing unit (CPU) continues execution from where it left off prior to entering hibernation mode.

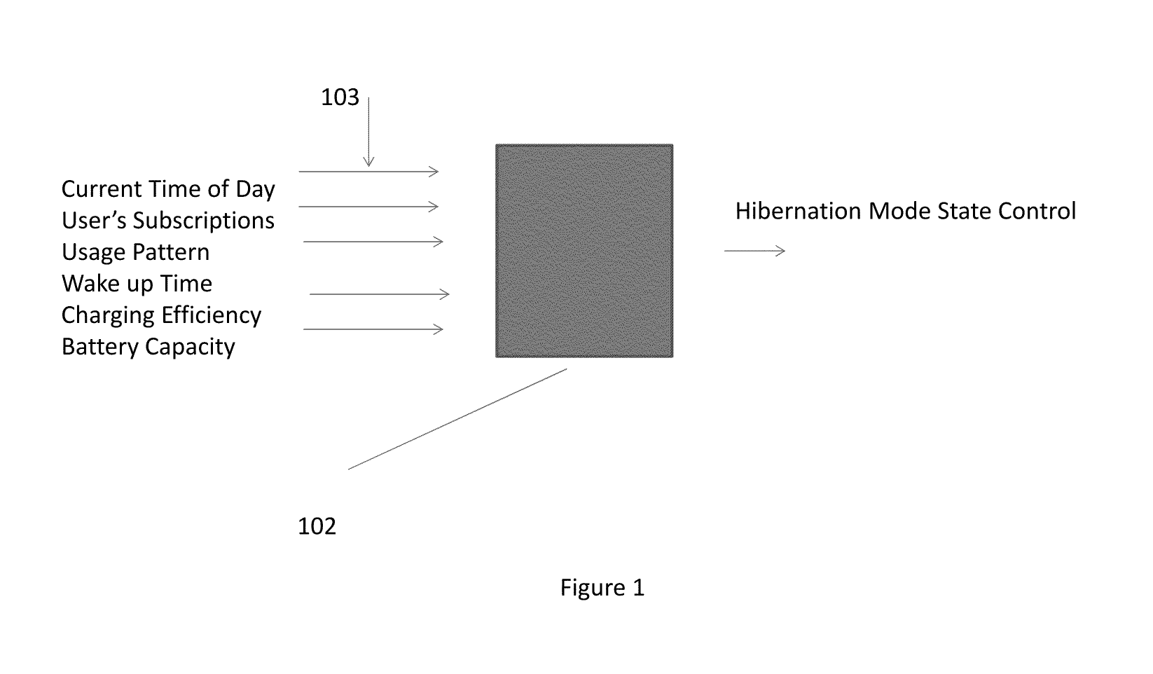

Referring to FIG. 1, a block diagram of an apparatus to determine hibernation policy control is depicted. The block 102 receives a plethora of inputs 103 to determine whether a hibernation mode should be entered for an electronic device. For example, the inputs could be all or a combination of the following current time of day, user's subscriptions, next scheduled wake up time to receive periodicals from a central server, device's charging efficiency, current battery capacity, and usage patterns. The following figures will provide more examples on defining the entering of hibernation mode. The resulting output signal determines whether the electronic device should enter hibernation mode.

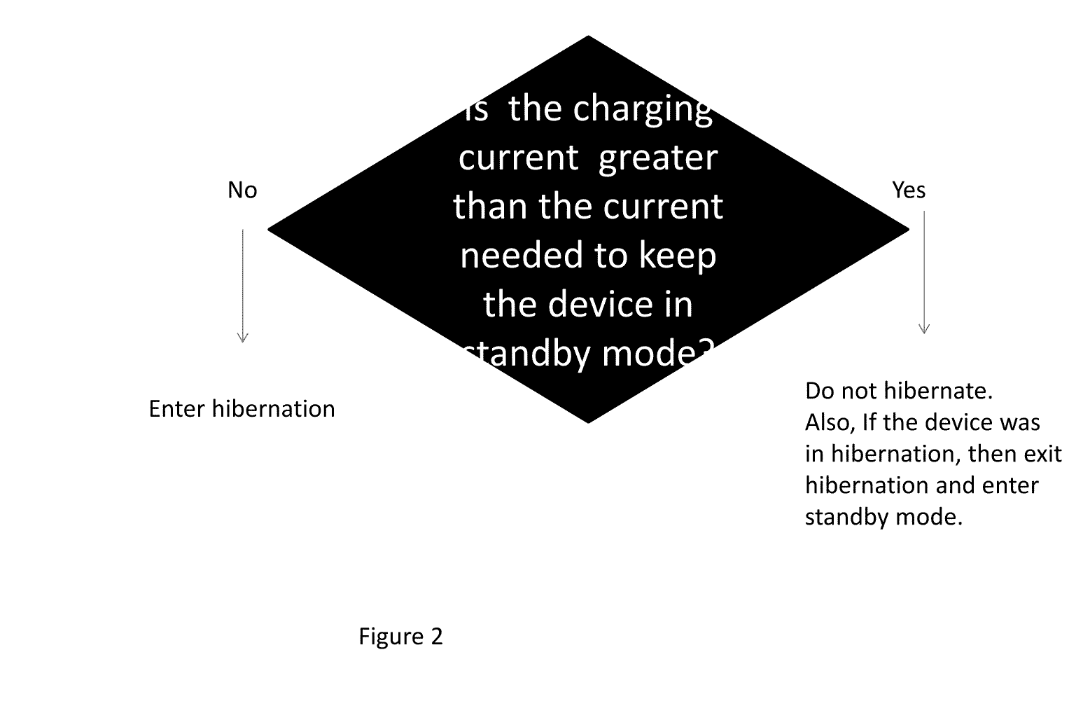

Referring to FIG. 2, a decision tree determines whether the device is being charged in any means, and specifically whether the charging current is greater than the current needed to keep the device in standby mode. If not, then enter hibernation mode. Otherwise, if so, the device does not enter hibernation mode. Also, if the device was in hibernation mode, it should exit hibernation and enter standby mode.

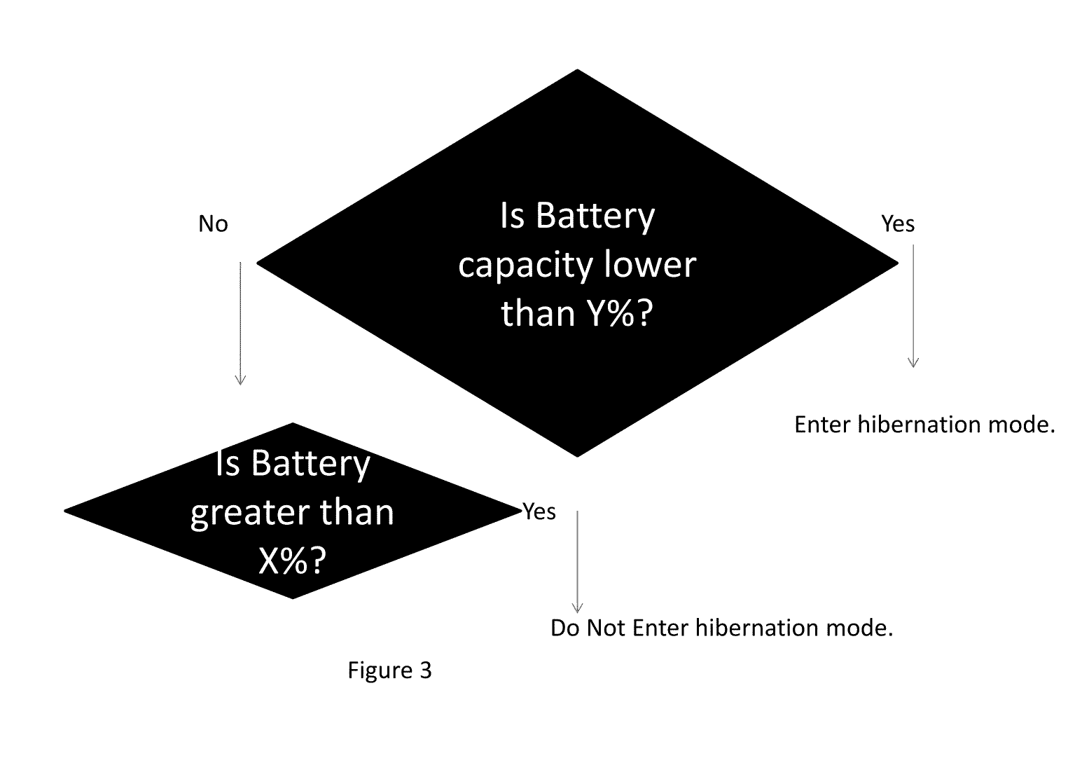

Referring to FIG. 3, a decision tree determines whether the battery capacity has more than a predetermined variable, Y? If so, the device enters hibernation mode quickly after entering a standby or suspend mode. For example, in one embodiment, the variable Y could be less than ten percent (10%) capacity. However, the claimed subject matter is not limited to this percentage. It merely allows one example to be depicted.

In the following embodiments, a time in hibernation analysis is performed. For example, use the following definitions for variables apply:
Let the energy needed to put the device in hibernation and to bring the device out of hibernation be defined as E(H).
Let the average current consumed during hibernation be defined as I(H)
Let the time spent in hibernation be defined as T(H)
Let the energy consumed during hibernation be defined as I(H)*T(H)
Let the average current consumed during suspend be defined as I(S)
Let the energy consumed during suspend be defined as I(S)*T(H)

Calculate the minimum hibernation time that has a net energy saving as follows:

E(H)+(I(H)*T(H))<I(S)*T(H)

T(H)*(I(S)−I(H)>E(H)

→T(H)>[E(H)/(I(S)−I(H))]

In this embodiment, hibernation mode should be used if the expected time in hibernation satisfies the last equation.

The following embodiments analyze usage patterns.

In one embodiment, the claimed subject matter continuously monitor and record the device's usage pattern, and establish the times “most likely to be used”. For example, it may be found the device is used for an hour starting around 7:00 am (user reading morning newspaper, and for two hours starting around 9:00 pm (evening book reading. Weekend patterns may be different than weekday patterns; in that case, the day of the week will be taken into account, in addition to the time of day.

The claimed subject matter accounts for the next scheduled automatic wake-up time. This wake-up time is stored in the device, and used to connect to a central server in order to download periodical subscriptions, check for software updates, upload any needed information, etc. Typically, this wake-up time is scheduled during the hours that most people are sleeping, in order not to inconvenience the user.

For some embodiments, the hibernation mode rules allow for:
Wait for X minutes after the device has gone from active mode to suspend mode.
After X minutes have passed, if the current time of day is not deemed to be appropriate for hibernation, do not hibernate; rather, wait for Y minutes before checking the time of day again. Reasoning: it may be the policy of the HPM only to hibernate at night, for example. In other policies, there may not be times of day which are off-limits.
If the time of day is appropriate for hibernation, calculate the minimum hibernation time T(H) using the formula above.
Add the calculated T(H) to the current time of day; let this result be defined as T(+)
If no device usage is expected (looking at the device's typical usage patterns AND no scheduled wake-up time is expected between the current time and T(+), go into hibernation. Otherwise, wait for Y minutes before applying the algorithm again.
If the device is activated (out of suspend) at any time, all the times and calculations above are discarded and will be recomputed the next time that the device goes into suspend mode again.

For the preceding examples and rules, the claimed subject matter is not limited to the specific hours and times. Rather, they merely facilitate the general methods and algorithms utilized.

A few more examples of embodiments for different user scenarios:
Sample scenario #1: It is 11:00 pm. The device has gone to suspend mode. The HPM policy is to wait for 1 hour before considering hibernation. Schedule a check in 1 hour.
It is midnight; the device is still in suspend mode. The estimated minimum T(H) is 3 hours. The next scheduled wake up time is at 5:00 am, and the next typical device use will be at 7:30 am. The device's battery is not receiving any charge at all, and the battery charge is 60%; the hibernation policy is not to hibernate only if the battery's charge is greater than 90%. Consequently, the DEVICE WILL GO INTO HIBERNATION.
Sample scenario #2: It is 9:00 am. The device has gone to suspend mode. The HPM policy is to wait for 1 hour before considering hibernation. Schedule a check in 1 hour.
It is 10:00 am; the device is still in suspend mode. The estimated minimum T(H) is 2.5 hours. The next typical device use will be at 11:30 am. Consequently, the DEVICE WILL NOT GO INTO HIBERNATION. Also, schedule another check in 3 hours, assuming that the device has remained in suspend mode all the time.

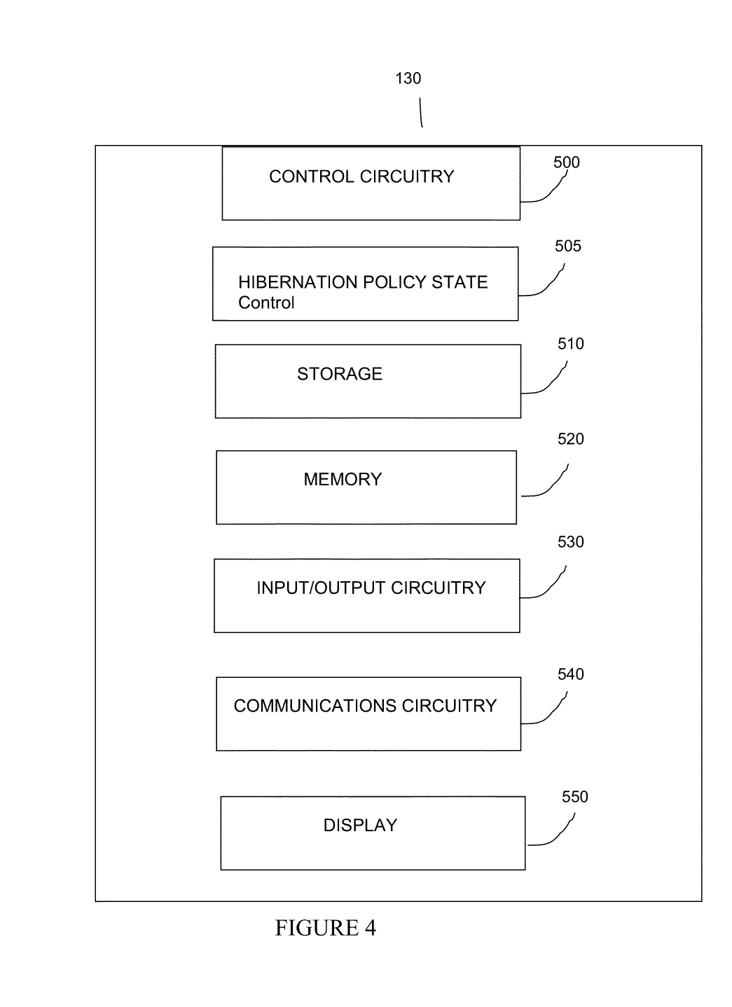

FIG. 4 illustrates exemplary device 200. As appreciated by those skilled the art, the device 200, can take many forms capable of operating the present invention. In a preferred embodiment the device 200 is a mobile electronic device. Device 200 can include control circuitry 500, storage 510, memory 520, input/output (“I/O”) circuitry 530, communications circuitry 540, and display 550. In some embodiments, one or more of the components of device 200 can be combined or omitted, e.g., storage 510 and memory 520 may be combined. As appreciated by those skilled in the art, device 200 can include other components not combined or included in those shown in this Figure, e.g., a power supply such as a battery, an input mechanism, etc.

Device 200 can include any suitable type of electronic device. For example, electronic device 200 can include a portable electronic device that the user may hold in his or her hand, such as a digital media player, a personal e-mail device, a personal data assistant (“PDA”), a cellular telephone, a handheld gaming device, a tablet device or an eBook reader. As another example, device 200 can include a larger portable electronic device, such as a laptop computer. The invention can also operate on a desktop computer, and can be run through a web application.

Control circuitry 500 can include any processing circuitry or processor operative to control the operations and performance of e device 200. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Hibernation Policy State Control Module 505 includes the hardware and software required to perform the hibernation state control hardware and software described herein. For example, the previous methods and claimed subject matter that were discussed in connection with FIGS. 1, 2, and 3, for the different inputs to determine whether the device should enter a hibernation mode. The control module 505 could be comprised of hardware and/or software and implement all or only a subset of the previously described algorithms, methods, and inputs to determine a hibernation mode of operation.

Storage 510 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 200, firmware, user preference information data, e.g., content preferences, authentication information, e.g., libraries of data associated with authorized users, transaction information data, e.g., information such as credit card information, wireless connection information data, e.g., information that can enable electronic device 200 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 200. Although I/O circuitry 530 is illustrated in this Figure as a single component of electronic device 200, several instances of I/O circuitry 530 can be included in electronic device 200.

Device 200 can include any suitable interface or component for allowing a user to provide inputs to I/O circuitry 530. For example, device 200 can include any suitable input mechanism, such as a button, keypad, dial, a click wheel, or a touch screen, e.g., display 550. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers, e.g., mono or stereo speakers, built into device 200, or an audio component that is remotely coupled to electronic device 200, e.g., a headset, headphones or earbuds that can be coupled to device 200 with a wire or wirelessly.

Display 550 includes the display and display circuitry for providing a display visible to the user. For example, the display circuitry can include a screen, e.g., an LCD screen that is incorporated in device 200. In some embodiments, the display circuitry can include a coder/decoder (Codec) to convert digital media data into analog signals. For example, the display circuitry or other appropriate circuitry within electronic device can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 200, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from the electronic device 200 to other devices within the communications network. Communications circuitry 540 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 200 can include one more instances of communications circuitry 540 for simultaneously performing several communications operations using different communications networks, although only one is shown in this Figure to avoid overcomplicating the drawing. For example, electronic device 200 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, device 200, can be coupled to a host device such as a cloud for data transfers, synching the communications device, software or firmware updates, providing performance information to a remote source, e.g., providing riding characteristics to a remote server, or performing any other suitable operation that can require electronic device 200 to be coupled to a host device. Several electronic devices 200 can be coupled to a single host device using the host device as a server. Alternatively or additionally, electronic device 200 can be coupled to several host devices, e.g., for each of the plurality of the host devices to serve as a backup for data stored in device 200.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A computer readable medium comprising a plurality of instructions to facilitate operation of an electronic device, the instructions to perform a process comprising:
configure an electronic device based on a usage pattern of an electronic device;
enable the electronic device to enter a hibernation mode of operation based at least in part on the usage pattern and an equation for determining whether to enter the hibernation mode or remain in a standby mode for the electronic device.

2. The computer readable medium of claim 1 further comprising:
prevent the electronic device to enter the hibernation mode based on a wake-up time of the electronic device.

3. The computer readable medium of claim 1 wherein: the wake-up time is a predetermined time for the electronic device to receive periodical subscriptions from a central server.

4. The computer readable medium of claim 3 wherein: the wake-up time is a user configured time for the electronic device to receive periodical subscriptions from a central server.

5. The computer readable medium of claim 4 wherein: the electronic device is to remain in a standby mode of operation prior to the wake-up time and after completion of receiving the periodical subscriptions from the central server.

6. The computer readable medium of claim 5 wherein: the electronic device is to remain in the suspend mode of operation prior to the wake-up time and after completion of receiving the periodical subscriptions from the central server.

7. The computer readable medium of claim 1 wherein the equation comprises: T(H)>[E(H/(I(S)−I(H))], wherein E(H) is the energy needed to put the device in hibernation and to bring the device out of hibernation, I(H) is the average current consumed during hibernation, T(H) is the time spent in hibernation.

8. A method for managing modes of operation for an electronic device comprising:
setting a wake-up time of an electronic device;
transitioning the electronic device to enter a hibernation mode of operation based at least in part on an equation to determine whether to enter the hibernation mode or remain in a standby mode and the wake-up time of the electronic device.

9. The method of claim 8 wherein:
transitioning the electronic device to enter the hibernation mode after a predetermined amount of time in a suspend mode of operation.

10. The method of claim 8 further compromising:
preventing the transition to the hibernation mode prior to the wake-up time and until completion of receiving the periodical subscriptions from the central server.

11. The method of claim 8 wherein setting of the wake-up time is programming a time for the electronic device to receive periodical subscriptions from a central server.

12. The method of claim 8 wherein the charging efficiency is based on whether a charging current is greater than a current needed for standby mode of operation of the electronic device.
